(19) United States
(12) Patent Application Publication
(10) Pub. No.: US 2023/0253172 A1
(43) Pub. Date: Aug. 10, 2023

(54) ELECTROMAGNETIC RELAY

(71) Applicant: OMRON Corporation, Kyoto-shi (JP)

(72) Inventors: Ayaka MIYAKE, Kyoto-shi (JP); Kazuhiro TSUTSUI, Kyoto-shi (JP)

(21) Appl. No.: 18/104,790

(22) Filed: Feb. 2, 2023

(30) Foreign Application Priority Data
Feb. 8, 2022 (JP) 2022-017887

(51) Int. Cl. H01H 50/54; H01H 50/14; H01H 50/44

(52) U.S. Cl. CPC H01H 50/54; H01H 50/14; H01H 50/44

(57) ABSTRACT

An electromagnetic relay includes a fixed terminal, a base, a fixed contact, a movable contact, a movable contact piece, a movable terminal, a card, and a contact protrusion. The base supports the fixed terminal. The fixed contact is connected to the fixed terminal. The movable contact faces the fixed contact. The movable contact is connected to the movable contact piece. The movable terminal is fixed to the base. The movable terminal is connected to the movable contact piece. The card pushes the movable contact piece to move the movable contact. The contact protrusion is provided on the movable contact piece. The contact protrusion contacts the card to allow the card to press the movable contact piece.

### CROSS-REFERENCE TO RELATED APPLICATION

This application claims priority to Japanese Patent Application No. 2022-17887, filed Feb. 8, 2022. The contents of that application are incorporated by reference herein in their entirety.

### FIELD

The present invention relates to an electromagnetic relay.

### BACKGROUND

Some electromagnetic relays open and close contacts by pressing a movable contact piece with a card. For example, in the electromagnetic relay disclosed in Japanese Patent Application Laid-Open No. 2021-144951, the magnetic force generated by the coil attracts the armature to the iron core. Thereby, the armature rotates and presses the card. The card is rotated by being pressed by the armature and presses the movable contact piece. The movable contact piece is elastically deformed by being pressed by the card. A movable contact is connected to the movable contact piece, and elastic deformation of the movable contact piece causes the movable contact to move toward the fixed contact. Thereby, the movable contact contacts the fixed contact. Also, the card includes a protrusion so that the card stably presses the movable contact piece. When the protrusion of the card contacts the movable contact piece, the card presses the movable contact piece.

### SUMMARY

The card is usually made of resin. Therefore, there is a possibility that an error occurs in the pressed position of the movable contact piece by the card due to a dimensional error in the protrusion of the card. Also, the card moves according to the rotation of the armature. Therefore, the card has a certain degree of wobble, and it is not easy to stabilize the pressed position of the movable contact piece by the card. An object of the present invention is to stabilize a pressed position of a movable contact piece by a card in an electromagnetic relay.

An electromagnetic relay according to one aspect of the present invention includes a fixed terminal, a base, a fixed contact, a movable contact, a movable contact piece, a movable terminal, a card, and a contact protrusion. The base supports the fixed terminal. The fixed contact is connected to the fixed terminal. The movable contact faces the fixed contact. The movable contact is connected to the movable contact piece. The movable terminal is fixed to the base. The movable terminal is connected to the movable contact piece. The card pushes the movable contact piece to move the movable contact. The contact protrusion is provided on the movable contact piece. The contact protrusion contacts the card to allow the card to press the movable contact piece.

In the electromagnetic relay according to the present aspect, the contact protrusion is provided on the movable contact piece. The movable contact piece is made of electric conductive metal. Therefore, the dimensional accuracy of the contact protrusion is higher than in the case where the contact protrusion is provided on a card made of resin. Also, the movable contact piece is fixed to the base via the movable terminal. Therefore, compared with the card, the movable contact piece has almost no rattling. Therefore, by providing the contact protrusion on the movable contact piece, the pressed position of the movable contact piece by the card is stabilized.

The contact protrusion may protrude toward the card. In this case, the card is stably pressed by the contact protrusion.

The contact protrusion may be integrally formed with the movable contact piece. In this case, the pressed position of the movable contact piece by the card is further stabilized.

The card may include a flat contact surface facing the contact protrusion. In this case, the pressed position of the movable contact piece by the card is further stabilized.

The electromagnetic relay may further include a spool, a coil, an iron core, an armature, and a hinge spring. The coil may be wound on the spool. The iron core may be disposed in the spool. The armature may be connected to the card. The armature may be rotatable by being attracted to the iron core. The hinge spring may bias the armature. In this case, the card moves according to the rotation of the armature. Therefore, the card has some rattling. In the electromagnetic relay according to the present aspect, since the contact protrusion is provided on the movable contact piece, the pressed position of the movable contact piece is stabilized even if the card is loose.

The movable contact piece may include a vertical portion, a lateral portion, and a contact support portion. The vertical portion may be connected to the movable terminal and extend upward. The lateral portion may extend laterally from the vertical portion. The contact support portion may extend downwardly from the lateral portion and support the movable contact. The contact protrusion may be provided on the contact support portion. In this case, the degree of freedom in the twisting direction of the contact support portion is high. In the electromagnetic relay according to the present aspect, since the contact protrusion is provided on the movable contact piece, the pressed position of the movable contact piece is stabilized even if the degree of freedom in the twisting direction of the contact support portion is high.

The movable contact piece may include a hole. The card may include a guide protrusion that extends through the hole. The contact protrusion may be disposed adjacent to the hole. In this case, the pressed position of the movable contact piece by the card is further stabilized.

### BRIEF DESCRIPTION OF THE DRAWINGS

FIG. 1 is a perspective view of an electromagnetic relay according to an embodiment.

FIG. 2 is a side view of the electromagnetic relay.

FIG. 3 is a side view of the electromagnetic relay.

FIG. 4 is an enlarged side view of a pressing portion and a contact device.

FIG. 5 is an enlarged side view of the pressing portion and the contact device.

FIG. 6 is a perspective view of a movable contact piece.

FIG. 7 is a diagram showing the movable contact piece according to a modification.

### DETAILED DESCRIPTION

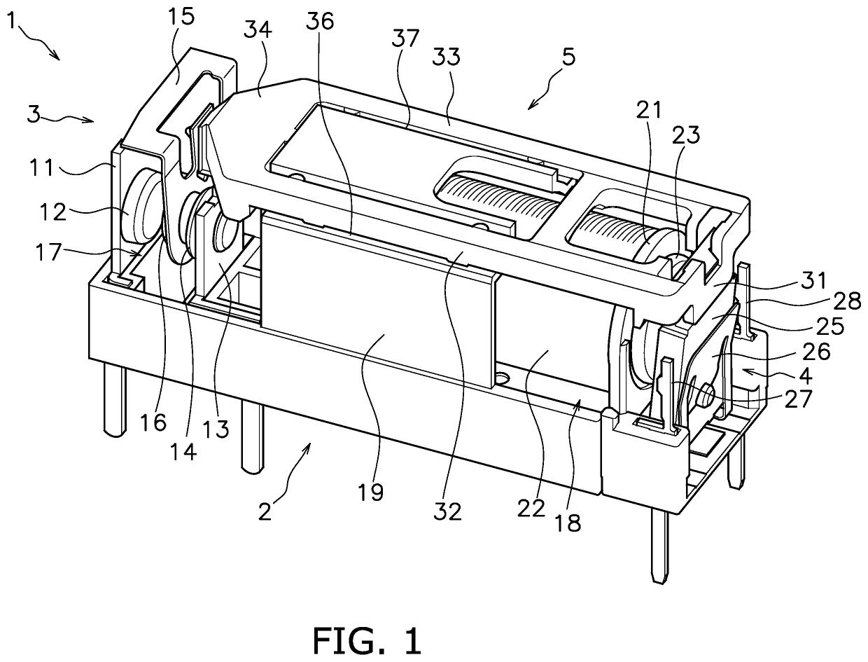

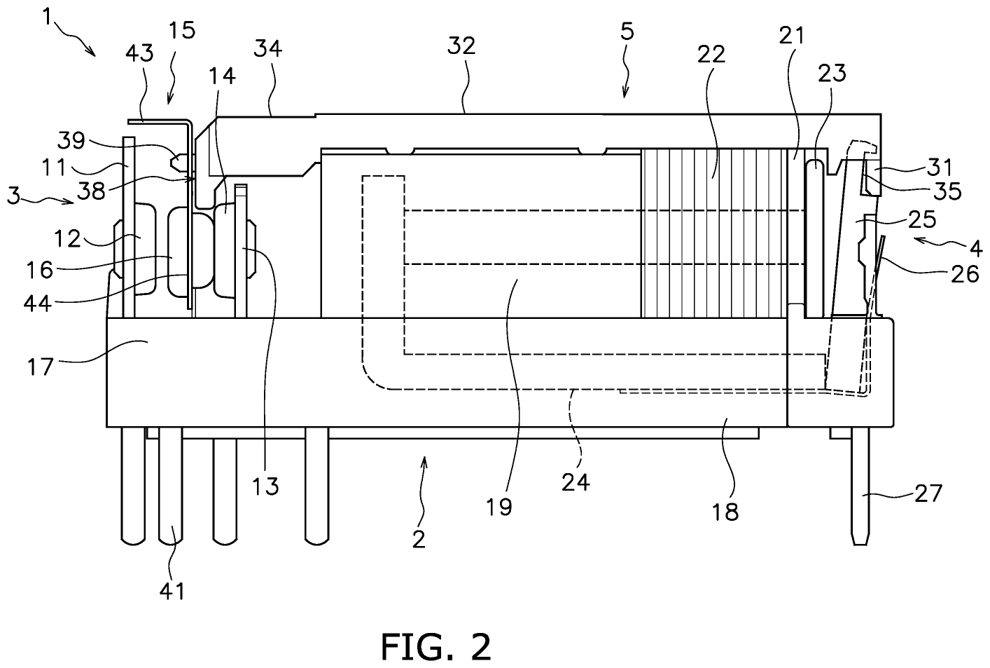

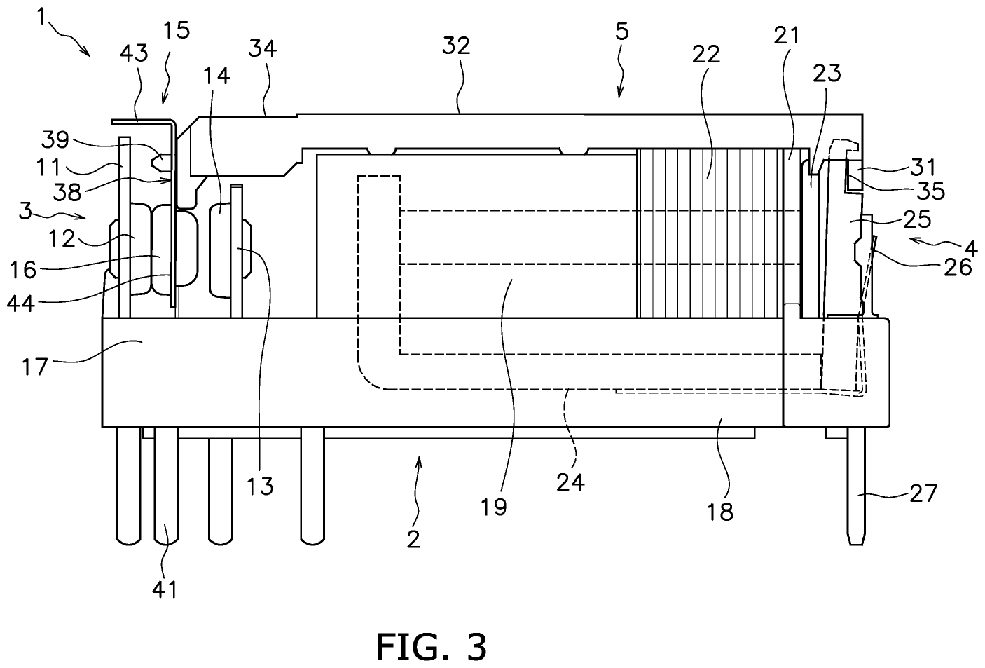

Hereinafter, an electromagnetic relay according to an embodiment will be described with reference to the drawings. FIG. 1 is a perspective view of an electromagnetic relay 1 according to an embodiment. FIGS. 2 and 3 are side views of the electromagnetic relay 1. As shown in FIGS. 1 to 3, the electromagnetic relay 1 includes a base 2, a contact device 3, a coil block 4, and a card 5.

The base 2 supports the contact device 3, the coil block 4, and the card 5. The base 2 is made of resin. The base 2 is covered with a case (not shown). The contact device 3 includes a first fixed terminal 11, a first fixed contact 12, a second fixed terminal 13, a second fixed contact 14, a movable terminal 41, a movable contact piece 15, and a movable contact 16. The first fixed terminal 11, the second fixed terminal 13, the movable terminal 41, and the movable contact piece 15 are made of conductive metal such as copper. The first fixed terminal 11, the second fixed terminal 13, and the movable terminal 41 are supported by the base 2. The first fixed terminal 11, the second fixed terminal 13, and the movable terminal 41 protrude outside the base 2 through the base 2. The base 2 includes a terminal support portion 17. The first fixed terminal 11, the second fixed terminal 13, and the movable terminal 41 are passed through holes provided in the terminal support portion 17. The first fixed terminal 11, the second fixed terminal 13, and the movable terminal 41 are fixed to the base 2 by, for example, press fitting or adhesion.

The first fixed contact 12 is connected to the first fixed terminal 11. The second fixed contact 14 is connected to the second fixed terminal 13. The movable terminal 41 is connected to the movable contact piece 15. The movable contact 16 is connected to the movable contact piece 15. The movable contact 16 faces the first fixed contact 12 and the second fixed contact 14. The movable contact 16 is disposed between the first fixed contact 12 and the second fixed contact 14.

In the following description, a direction from the terminal support portion 17 of the base 2 to the contacts 12, 14, and 16 is defined as upward, and the opposite direction is defined as downward. A direction from the movable contact 16 to the first fixed terminal 11 is defined as front, and the opposite direction is defined as rear. A direction perpendicular to the up-down direction and the front-rear direction is defined as the left-right direction, or the lateral direction. The left and right directions toward the front are defined as left and right, respectively.

The coil block 4 is disposed behind the contact device 3. The coil block 4 includes a spool 21, a coil 22, an iron core 23, a yoke 24, an armature 25, and a hinge spring 26. The coil 22 is wound around the spool 21. The coil terminals 27 and 28 are connected to the coil 22. The iron core 23 is disposed in the spool 21. The yoke 24 is connected to the iron core 23 and the armature 25.

The armature 25 is rotatably supported around a lower end of the armature 25. The armature 25 rotates to move between a first position shown in FIG. 2 and a second position shown in FIG. 3. The hinge spring 26 is connected to the armature 25. The hinge spring 26 is fitted between the base 2 and the yoke 24. The armature 25 is connected to the card 5. The hinge spring 26 is a plate spring and biases the armature 25 toward the first position. The base 2 includes a coil support portion 18. The coil support portion 18 supports the coil block 4.

The card 5 pushes the movable contact piece 15 to move the movable contact 16. The card 5 is made of resin. The card 5 is disposed above the coil block 4. The card 5 includes a connecting portion 31, guide rails 32 and 33, and a pressing portion 34. The connecting portion 31 is connected to the armature 25. As shown in FIG. 2, a concave groove 35 is provided on an upper portion of the armature 25. The connecting portion 31 is engaged to the armature 25 by being disposed in the concave groove 35.

The guide rails 32 and 33 are disposed between the connecting portion 31 and the pressing portion 34. The guide rails 32 and 33 are disposed above the coil block 4. The guide rails 32 and 33 extend forward from the connecting portion 31. The base 2 includes a card support portion 19. The card support portion 19 extends upward from the coil support portion 18. The guide rails 32 and 33 are supported by the card support portion 19. As the guide rails 32 and 33 slide on the card support portion 19, the card 5 moves forward and backward.

Specifically, the guide rails 32 and 33 include a first guide rail 32 and a second guide rail 33, as shown in FIG. 1. The first guide rail 32 and the second guide rail 33 are disposed apart from each other in the left-right direction. The card support portion 19 includes a first guide groove 36 and a second guide groove 37. The first guide groove 36 and the second guide groove 37 extend in the front-rear direction. The first guide rail 32 is disposed on the first guide groove 36. The second guide rail 33 is disposed on the second guide groove 37. The first guide rail 32 slides on the first guide groove 36. The second guide rail 33 slides on the second guide groove 37. As a result, the card 5 moves forward and backward.

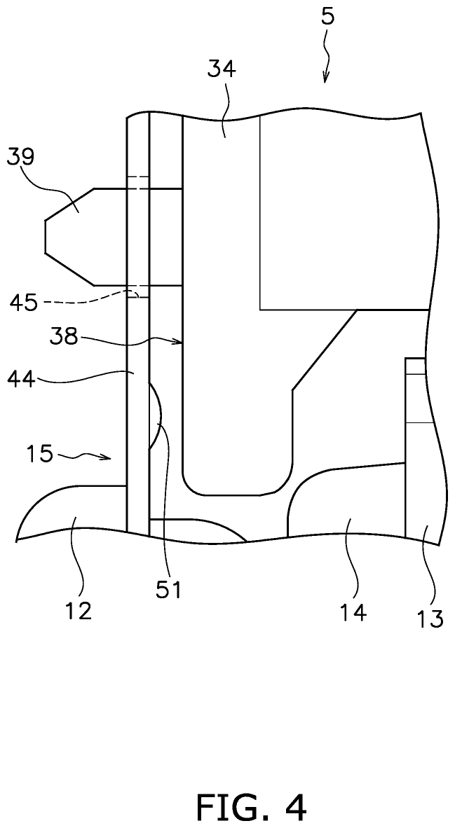

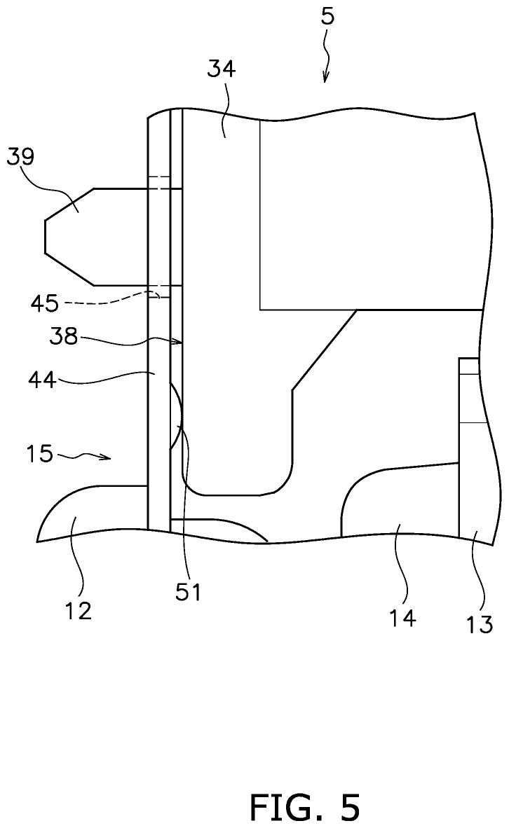

The pressing portion 34 is disposed above the second fixed terminal 13. The pressing portion 34 has a shape that tapers forward. FIGS. 4 and 5 are enlarged side views of the pressing portion 34 and the contact device 3. As shown in FIG. 4, the pressing portion 34 includes a contact surface 38 and a guide protrusion 39. The contact surface 38 is provided at the front end of the pressing portion 34. The contact surface 38 is disposed behind the movable contact piece 15. The contact surface 38 faces the movable contact piece 15. The contact surface 38 has a flat shape. The guide protrusion 39 protrudes forward from the contact surface 38.

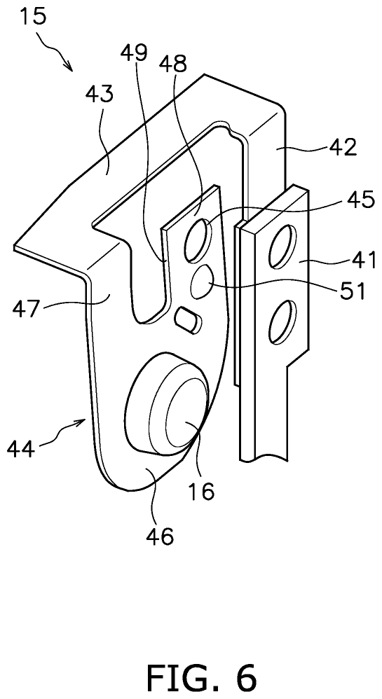

FIG. 6 is a perspective view of the movable contact piece 15. As shown in FIG. 6, the movable contact piece 15 includes a vertical portion 42, a lateral portion 43, and a contact support portion 44. The vertical portion 42 is connected to the movable terminal 41. The vertical portion 42 is provided separately from the movable terminal 41 and is connected to the movable terminal 41 by caulking or welding. However, the vertical portion 42 may be integrated with the movable terminal 41.

The vertical portion 42 extends upward from base 2. The vertical portion 42 has a flat plate-like shape. The lateral portion 43 is connected to an upper end of the vertical portion 42. One end of the lateral portion 43 in the left-right direction is connected to the vertical portion 42. The other end of the lateral portion 43 in the left-right direction is connected to the contact support portion 44. The lateral portion 43 is bent with respect to the vertical portion 42. The lateral portion 43 is bent with respect to the contact support portion 44. The lateral portion 43 extends laterally from the vertical portion 42. The lateral portion 43 has a flat plate-like shape.

The contact support portion 44 extends downward from the lateral portion 43. The contact support portion 44 is suspended above the base 2 by the lateral portion 43, the vertical portion 42, and the movable terminal 41. The contact support portion 44 has a flat plate-like shape. The contact support portion 44 supports the movable contact 16. The movable contact 16 is attached to the contact support portion 44. The contact support portion 44 includes a guide hole 45. The guide protrusion 39 of the card 5 is passed through the guide hole 45. The guide hole 45 has an inner diameter larger than an outer diameter of the guide protrusion 39.

Specifically, the contact support portion 44 includes a body portion 46, a first extending portion 47, and a second extending portion 48. The movable contact 16 is attached to the body portion 46. The first extending portion 47 and the second extending portion 48 extend upward from the body portion 46. The first extending portion 47 and the second extending portion 48 are disposed apart from each other in the left-right direction. A notch 49 that extends in the vertical direction is provided between the first extending portion 47 and the second extending portion 48. The first extending portion 47 is connected to the lateral portion 43. The guide hole 45 is provided in the second extending portion 48.

A contact protrusion 51 is provided on the movable contact piece 15. The contact protrusion 51 contacts the card 5 to allow the card 5 to press the movable contact piece 15. The contact protrusion 51 is disposed in front of the contact surface 38 of the card 5. The contact protrusion 51 faces the contact surface 38. The contact protrusion 51 protrudes toward the contact surface 38. The contact protrusion 51 is formed integrally with the movable contact piece 15. For example, the contact protrusion 51 is formed on the movable contact piece 15 by pressing.

The contact protrusion 51 has a curved shape protruding toward the card 5. For example, the contact protrusion 51 has a hemispherical shape. Alternatively, the contact protrusion 51 may have other shapes such as semi-cylindrical. The contact protrusion 51 is provided on the contact support portion 44. The contact protrusion 51 is disposed adjacent to the guide hole 45. The contact protrusion 51 is disposed below the guide hole 45. However, the contact protrusion 51 may be disposed above the guide hole 45.

Next, operation of the electromagnetic relay 1 will be described. When the coil 22 is not energized, the biasing force of the hinge spring 26 holds the armature 25 at the first position shown in FIG. 2. When the armature 25 is located in the first position, the card 5 is located in a non-contact position shown in FIG. 2. As shown in FIG. 4, when the card 5 is located in the non-contact position, the contact surface 38 is apart from the contact protrusion 51 and is not in contact with the contact protrusion 51. Therefore, as shown in FIG. 2, when the card 5 is located at the non-contact position, the movable contact 16 is apart from the first fixed contact 12 and contacts the second fixed contact 14.

When the coil 22 is energized and excited, the armature 25 is attracted to the iron core 23 by magnetic force. Thereby, the armature 25 moves from the first position shown in FIG. 2 to the second position shown in FIG. 3. That is, the upper portion of the armature 25 moves forward as the armature 25 rotates around the lower end. As the armature 25 moves, the card 5 moves forward to move from the non-contact position shown in FIG. 2 to the contact position shown in FIG. 3. As shown in FIG. 5, when the card 5 is located at the contact position, the contact surface 38 contacts the contact protrusion 51 to press the movable contact piece 15 forward. As a result, the movable contact piece 15 elastically deforms forward, and the movable contact 16 moves forward. As a result, the movable contact 16 moves away from the second movable contact 16 and contacts the first fixed contact 12, as shown in FIG. 3.

When the energization of the coil 22 is stopped and demagnetized, the biasing force of the hinge spring 26 moves the armature 25 from the second position shown in FIG. 3 to the first position shown in FIG. 2. That is, the upper portion of the armature 25 moves rearward by rotating the armature 25 around the lower end. In accordance with the movement of the armature 25, the card 5 moves backward to move from the contact position shown in FIG. 3 to the non-contact position shown in FIG. 2. Thereby, the contact surface 38 is apart from the contact protrusion 51 as shown in FIG. 4. As a result, the movable contact 16 moves away from the first fixed contact 12 and contacts the second fixed contact 14, as shown in FIG. 2.

In the electromagnetic relay 1 according to the present embodiment described above, the contact protrusion 51 is provided on the movable contact piece 15. The movable contact piece 15 is made of conductive metal. Therefore, the dimensional accuracy of the contact protrusion 51 is higher than when the contact protrusion 51 is provided on the card 5 made of resin. Also, the movable contact piece 15 is fixed to the base 2 via the movable terminal 41. Therefore, the movable contact piece 15 does not rattle as compared with the card 5. Therefore, by providing the contact protrusion 51 on the movable contact piece 15, the pressed position of the movable contact piece 15 by the card 5 is stabilized.

Although one embodiment of the present invention has been described above, the present invention is not limited to the above-described embodiment, and various modifications are possible without departing from the gist of the invention.

The structure of the coil block 4 is not limited to that of the above embodiment, and may be modified. For example, in the embodiment described above, the direction of the axis of the coil 22 coincides with the moving direction of the card 5. However, the direction of the axis of the coil 22 may be different from the moving direction of the card 5.

The structure of the contact device 3 is not limited to that of the above embodiment, and may be modified. For example, the second fixed terminal 13 and the second fixed contact 14 may be omitted. Alternatively, the first fixed terminal 11 and the first fixed contact 12 may be omitted. The first fixed contact 12 may be provided separately from or integrated with the first fixed terminal 11. The second fixed contact 14 may be provided separately from or integrated with the second fixed terminal 13. The movable contact 16 may be provided separately from or integral with the movable contact piece 15.

The structure of the card 5 is not limited to that of the above embodiment, and may be modified. For example, in the above embodiment, the card 5 is slidably supported on the base 2. However, the card 5 may be rotatably supported by the base 2. The card 5 may be rotated by being pressed by the armature 25. The guide protrusion 39 of the card 5 and the guide hole 45 may be omitted.

The shape of the movable contact piece 15 is not limited to that of the above embodiment, and may be changed. For example, the movable contact piece 15 may have a linear shape. Alternatively, the movable contact piece 15 may have an L-shaped bent shape.

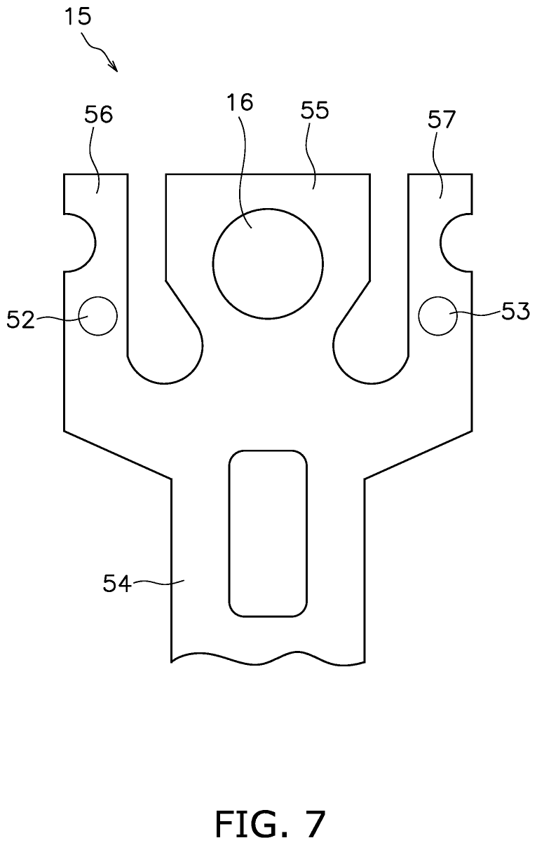

In the above embodiment, the number of the contact protrusion 51 is one. However, a plurality of contact protrusions may be provided on the movable contact piece 15. FIG. 7 is a diagram showing the movable contact piece 15 according to a modification. As shown in FIG. 7, the movable contact piece 15 may be provided with two contact protrusions 52 and 53. Alternatively, the number of contact protrusions may be greater than two.

As shown in FIG. 7, the movable contact piece 15 may include a vertical portion 54, a contact support portion 55, a first branch portion 56, and a second branch portion 57. The vertical portion 54 may be connected to the movable terminal 41 described above. The movable contact 16 may be connected to the contact support portion 55. The first branch portion 56 and the second branch portion 57 may be disposed apart from each other in the left-right direction. The first branch portion 56 may be disposed on one lateral side of the contact support portion 55 and the second branch portion 57 may be disposed on the other lateral side of the contact support portion 55. The first contact protrusion 52 may be provided on the first branch portion 56. The second contact protrusion 53 may be provided on the second branch portion 57. The card 5 may press the movable contact piece 15 by contacting the first contact protrusion 52 and the second contact protrusion 53.

### REFERENCE NUMERALS

2: Base, 5: Card, 11: First fixed terminal, 12: First fixed contact, 16: Movable contact, 15: Movable contact piece, 21: Spool, 22: Coil, 23: Iron core, 25: Armature, 26: Hinge spring, 38: Contact surface, 39: Guide protrusion, 41: Movable terminal, 43: Lateral portion, 45: Guide hole, 51: Contact protrusion, 54: Vertical portion, 55: Contact support portion

1. An electromagnetic relay comprising:
a fixed terminal;
a base that supports the fixed terminal;
a fixed contact connected to the fixed terminal;
a movable contact that faces the fixed contact;
a movable contact piece to which the movable contact is connected;
a movable terminal fixed to the base, the movable terminal being connected to the movable contact piece;
a card configured to press the movable contact piece to move the movable contact; and
a contact protrusion provided on the movable contact piece, the contact protrusion being disposed to contact the card to allow the card to press the movable contact piece.

2. The electromagnetic relay according to claim 1, wherein
the contact protrusion protrudes toward the card.

3. The electromagnetic relay according to claim 1, wherein
the contact protrusion is formed integrally with the movable contact piece.

4. The electromagnetic relay according to claim 1, wherein
the card includes a flat contact surface that faces the contact protrusion.

5. The electromagnetic relay according to claim 1, further comprising:
a spool;
a coil wound around the spool;
an iron core disposed in the spool;
an armature connected to the card, the armature being rotatable by being attracted to the iron core; and
a hinge spring that biases the armature.

6. The electromagnetic relay according to claim 1, wherein
the movable contact piece includes
a vertical portion connected to the movable terminal and extending upward,
a lateral portion extending laterally from the vertical portion, and
a contact support portion extending downward from the lateral portion and supporting the movable contact, and
the contact protrusion is provided on the contact support portion.

7. The electromagnetic relay according to claim 1, wherein
the movable contact piece includes a hole,
the card includes a guide protrusion extending through the hole, and
the contact protrusion is disposed adjacent to the hole.
